(19) United States
(12) Patent Application Publication
(10) Pub. No.: US 2007/0256080 A1
(43) Pub. Date: Nov. 1, 2007

(54) Xml/Soap Interprocess Intercontroller Communication

(75) Inventors: Les Smith, Pleasanton, CA (US); Mike Thiels, Gilroy, CA (US)

Correspondence Address: DICKSTEIN SHAPIRO LLP, 1825 EYE STREET NW, Washington, DC, 20006-5403, US

(73) Assignee: XYRATEX TECHNOLOGY LIMITED, HAVANT, HAMPSHIRE PO9 1SA (GB)

(21) Appl. No.: 11/662,951

(22) PCT Filed: Sep. 22, 2005
(86) PCT No.: PCT/US05/34217

§ 371 Date: Jun. 20, 2007

Related U.S. Application Data
(60) Provisional application No. 60/611,807, filed on Sep. 22, 2004.

(51) Int. Cl. G06F 13/00

(52) U.S. Cl. 719/313

(57) ABSTRACT

A method and system for interprocess communication (IPC) (300), which includes converting a message from the source computer process (310) into an extensible markup language (XML) document, and encoding the XML document into a simple object access protocol (SOAP) message. The SOAP message is transmitted to the destination computer process (312) via an interprocess communication (IPC) interface (326); The SOAP message is decoded to extract the XML document, and the XML document is translated to a language usable by the destination computer process. The system of IPC includes source (310) and destination (312) processes that have both XML layers (318 and 320) and SOAP layers (314 and 316) to effectuate transfer of messages in a way that is not application- or platform-specific. The computer processes may run on at least one redundant array of independent disks (RAID) controller (130).

### CROSS-REFERENCE TO RELATED APPLICATIONS

This application claims the benefit of U.S. Provisional Application Ser. No. 60/611,807, filed Sep. 22, 2004 in the U.S. Patent and Trademark Office, the entire content of which is incorporated by reference herein.

### FIELD OF THE INVENTION

The present invention relates to communication between two or more computing processes and, more specifically, to a system that uses SOAP (Simple Object Access Protocol) and XML (Extensible Markup Language) for interprocess communication (IPC) between non-specific computing systems.

### BACKGROUND OF THE INVENTION

In today's computing environment, computing systems and devices are required to support an increasing number of concurrent processes. Software programs, hardware components, peripheral devices, and networking communications are several examples of computing components that perform a series of individual tasks, each of which may require more than one concurrent process. The processes can be running on the same computing device on a single processor, the same computing device across multiple processors, or across multiple computing devices, each of which has either a single or multiple processors, connected via a conventional network. Furthermore, these processes may be required to communicate with one another through IPC.

Computer programmers who design program components have a number of conventional IPC interfaces available for creating and managing concurrent individual processes. Examples of such interfaces include signals, message queuing, pipes, sockets, shared memory, and semaphores. Each IPC interface has its own advantages and disadvantages, and as a result, an IPC interface is often chosen based on processor architecture, software development language, or other computer-specific characteristic. One rudimentary example of a shared memory IPC is described in U.S. Pat. No. 6,519,686, entitled, “Information Streaming in a Multi-Process System Using Shared Memory.” The '686 patent describes a method and system for streaming information from a producer to n consumers in a multi-process environment. An inter-process communication IPC channel that contains a shared memory is provided between the producer and at least one of n consumers. The information stream is written into the shared memory by way of a producer-side interface. The information stream is read from the shared memory by way of a consumer-side interface.

While the '686 patent illustrates an effective use of shared memory to achieve IPC, it assumes that each computer or device contains and understands the same shared memory IPC interface. This solution works reasonably well when a single entity has the authority to define an IPC standard and all communication occurs by this standard. Often, however, computing systems must be designed to communicate with numerous other systems that employ non-specific IPC. Therefore, most IPC involves two or more processors or processes that use two or more distinct IPC interfaces. As a result, computing systems must be developed that communicate with a number of other systems that use very different IPC interfaces. What is needed is a means for different processes to communicate with one another, even if they are, for example, of different architectures, different software or firmware versions, or different byte storage techniques.

Further, computing components, such as software or firmware, are often updated, for example, to fix bugs, add features, and provide enhancements. Typically, this involves updating, recompiling, and redistributing the component. One common problem encountered with updating and changing the scheme of components is that IPC communication with other components often no longer works, because the schemas are now different. What is needed is a means of upgrading computing components without impacting communication with other components.

It is therefore an object of this invention to allow non-specific communication between disparate computer systems to talk within an embedded space.

It is another object of the invention to upgrade computing components without affecting the communication processes of the components.

### BRIEF SUMMARY OF THE INVENTION

In one exemplary embodiment, the present invention provides a method for transferring a message from a source computer process to at least one destination computer process. The method includes the step of converting a message from the source computer process into an extensible markup language (XML) document, and then encoding the XML document into a simple object access protocol (SOAP) message. The SOAP message is transmitted to the at least one destination computer process via an interprocess communication (IPC) interface; After transmission, the SOAP message is then decoded to extract the XML document, and the XML document is translated to a language usable by the at least one destination computer process. The IPC interface may be a socket connection, and both the source and the at least one destination computer processes may be run on at least one redundant array of independent disks (RAID) controller.

In another exemplary embodiment, the present invention provides an interprocess communication (IPC) system. The system includes a plurality of controllers, a source computer process that runs on one of the controllers, and at least one destination computer process that also runs on at least one of the controllers. The system also includes an IPC interface configured to allow transmission of messages between the source computer process and the at least one destination computer process. A message is issued from the source computer process for use by the at least one destination computer process. The message is converted into an extensible markup language (XML) document and encoded into a simple object access protocol (SOAP) message by the source computer process. The destination computer process receives the SOAP message and decodes the SOAP message. The resulting XML document is translated by the destination computer process into a language usable by the at least one destination computer process.

In a further exemplary embodiment, the present invention provides an interprocess communication (IPC) system that includes an IPC interface configured to allow transmission of a first message between at least two computer processes. The system also includes a source computer process configured to use the IPC interface to send the first message, and a destination computer process configured to receive the first message. The source computer process includes a source extensible markup language (XML) layer configured to convert the first message into a first XML document. The source computer process also includes a source simple object access protocol (SOAP) layer configured to encode the first XML document into a first SOAP message. The destination computer process includes both a destination SOAP layer configured to decode the first SOAP message into the first XML document and a destination XML layer configured to convert the first XML document into a transmitted first message, where the transmitted first message is in a language usable by the destination computer process. The IPC interface may be a socket interface, and both the source and the destination computer processes may include sockets. Additionally, both the source and the destination computer processes may run on at least one redundant array of independent disks (RAID) controller.

In yet another exemplary embodiment, the present invention provides an interprocess communication (IPC) system that, like the above embodiment, includes an IPC interface configured to allow transmission of a first message between at least two computer processes. The system includes a source computer process configured to use the IPC interface to send the first message, and a destination computer process configured to receive the first message. The source computer process includes means to convert the first message into a first document that is not application- or platform-specific, as well as means to encode the first document with data to aid with transmission and interpretation of the first document. The destination computer process includes both means to decode the transmission and interpretation data sent with the first document and means to translate the first document into a transmitted first message, where the transmitted first message is in a language usable by the destination computer process. The IPC interface may be a socket interface, and both the source and the destination computer processes may include sockets. Additionally, both the source and the destination computer processes may run on at least one controller.

These and other aspects of the invention will be more clearly recognized from the following detailed description of the invention which is provided in connection with the accompanying drawings.

### BRIEF DESCRIPTION OF THE DRAWINGS

FIG. 1 illustrates a block diagram of a conventional RAID networked storage system in accordance with the invention;

FIG. 2 illustrates a block diagram of a RAID controller system in accordance with the invention; and

FIG. 3 illustrates a functional diagram of IPC between two processes that utilize SOAP and XML technologies in accordance with the invention.

### DETAILED DESCRIPTION OF THE INVENTION

The present invention is a system for interprocess communication (IPC) within embedded computing environments that use SOAP and XML. While IPC is described within the context of a redundant array of independent disks (RAID) controller system, those skilled in the art will appreciate that IPC is enabled for any computing system or device that uses the following components and configuration. A running process on a RAID controller or other computing system converts a command to XML and encodes the command into a SOAP message. The SOAP message is then sent via a socket to a second process that is running on either the same or a different RAID controller or other computing system. The SOAP message is decoded and utilized by the second process.

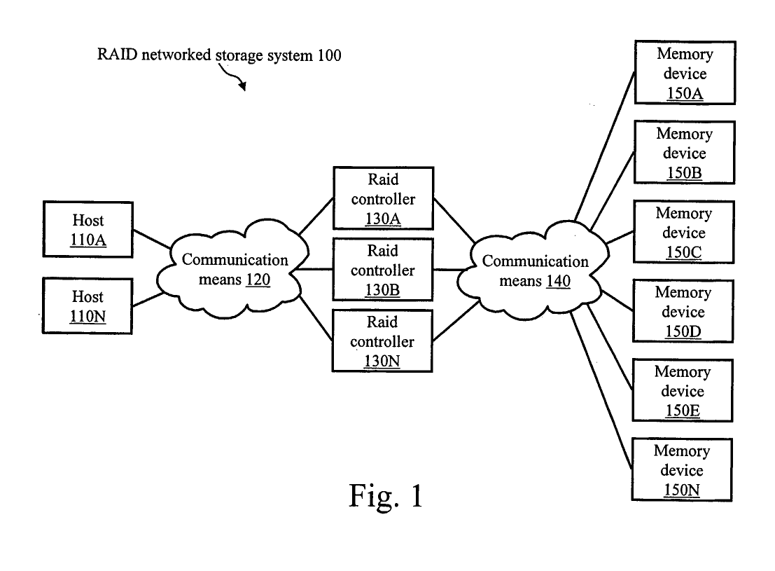

FIG. 1 is a block diagram of a conventional RAID networked storage system 100 that combines multiple small, independent disk drives into an array of disk drives that yields superior performance characteristics, such as redundancy, flexibility, and economical storage. Conventional RAID networked storage system 100 includes a plurality of hosts 110A through 110N, where ‘N’ is not representative of any other value ‘N’ described herein. Hosts 110 are connected to a communications means 120, which is further coupled via host ports (not shown) to a plurality of RAID controllers 130A and 130B through 130N, where ‘N’ is not representative of any other value ‘N’ described herein. RAID controllers 130 are connected through device ports (not shown) to a second communication means 140, which is further coupled to a plurality of memory devices 150A through 150N, where ‘N’ is not representative of any other value ‘N’ described herein. Memory devices 150 are housed within enclosures (not shown).

Hosts 110 are representative of any computer systems or terminals that are capable of communicating over a network. Communication means 120 is representative of any type of electronic network that uses a protocol, such as Ethernet. RAID controllers 130 are representative of any storage controller devices that process commands from hosts 110 and, based on those commands, from memory devices 150. RAID controllers 130 also provide data redundancy, based on system administrator programmed RAID levels. This includes data mirroring, parity generation, and/or data regeneration from parity after a device failure. Physical to logical and logical to physical mapping of data is also an important function of RAID controllers 150 that are related to the RAID level in use. Communication means 140 is any type of storage controller network, such as iSCSI (internet Small Computer System Interface) or fibre channel. Memory devices 150 may be any type of storage device, such as, for example, tape drives, disk drives, non-volatile memory, or solid state devices. Although most RAID architectures use disk drives as the main storage devices, it should be clear to one skilled in the art that the invention embodiments described herein apply to any type of memory device.

In operation, host 110A, for example, generates a read or a write request for a specific volume, (e.g., volume 1), to which it has been assigned access rights. The request is sent through communication means 120 to the host ports of RAID controllers 130. The command is stored in local cache in, for example, RAID controller 130B, because RAID controller 130B is programmed to respond to any commands that request volume 1 access. RAID controller 130B processes the request from host 110A and determines the first physical memory device 150 address from which to read data or to which to write new data. If volume 1 is a RAID 5 volume and the command is a write request, RAID controller 130B generates new parity, stores the new parity to the parity memory device 150 via communication means 140, sends a “done” signal to host 110A via communication means 120, and writes the new host 110A data through communication means 140 to the corresponding memory devices 150.

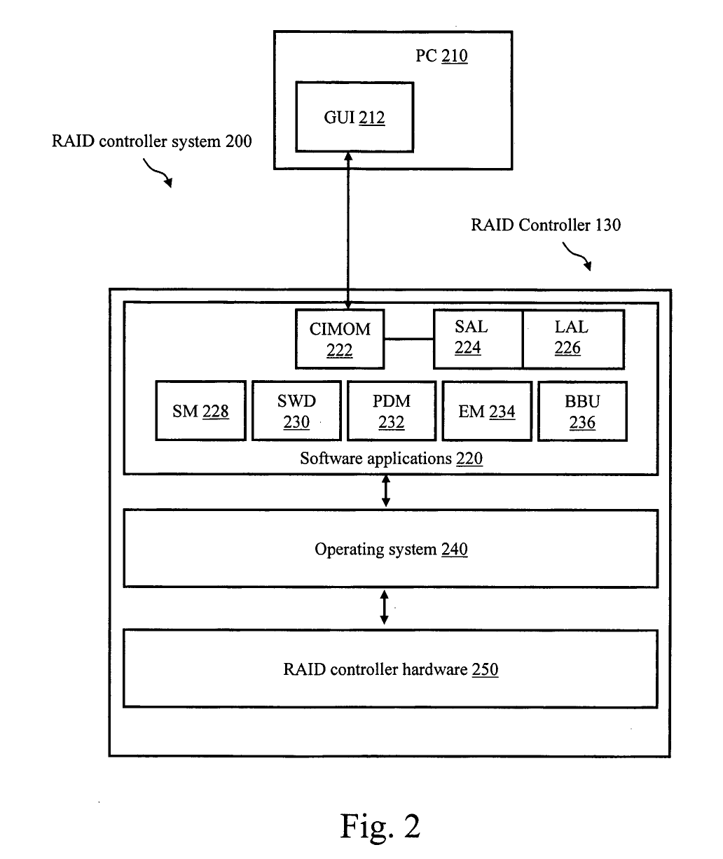

FIG. 2 is a block diagram of a RAID controller system 200. RAID controller system 200 includes RAID controllers 130 and a general purpose personal computer (PC) 210. PC 210 further includes a graphical user interface (GUI) 212. RAID controllers 130 further include software applications 220, an operating system 240, and a RAID controller hardware 250. Software applications 220 further include a common information module object manager (CIMOM) 222, a software application layer (SAL) 224, a logic library layer (LAL) 226, a system manager (SM) 228, a software watchdog (SWD) 230, a persistent data manager (PDM) 232, an event manager (EM) 234, and a battery backup (BBU) 236.

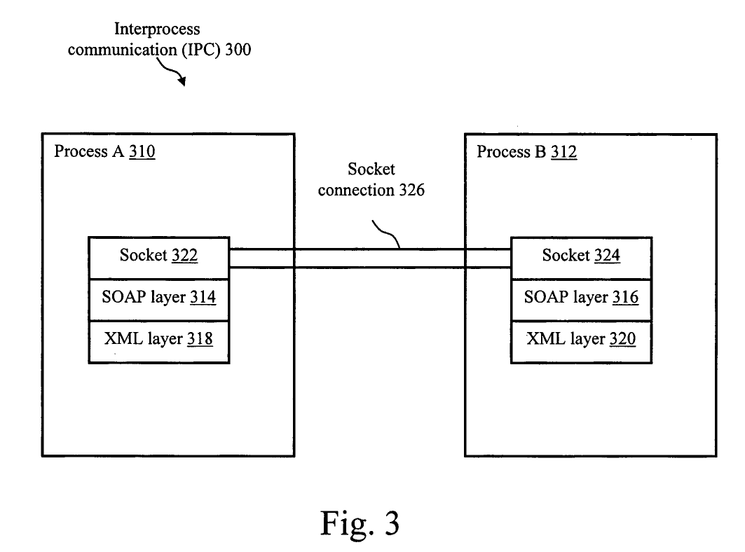

GUI 212 is a software application that is used to input personality attributes for RAID controllers 130. GUI 212 runs on PC 210. RAID controllers 130 are representative of RAID storage controller devices that process commands from hosts 110 and, based on those commands, from memory devices 150. The RAID controller 130 shown in FIG. 2 is an exemplary embodiment of the invention; however, other implementations of controllers may be envisioned here by those skilled in the art. RAID controllers 130 provide data redundancy, based on system-administrator-programmed RAID levels. This includes data mirroring, parity generation, and/or data regeneration from parity after a device failure. RAID controller hardware 250 is the physical processor platform of RAID controllers 130 that executes all RAID controller software applications 220 and that consists of a microprocessor, memory, and all other electronic devices necessary for RAID control, as described in detail in the discussion of FIG. 3. Operating system 240 is an industry-standard software platform, such as Linux, for example, upon which software applications 220 can run. Operating system 240 delivers other benefits to RAID controllers 130. Operating system 240 contains utilities, such as a file system, that provides a way for RAID controllers 130 to store and transfer files. Software applications 220 contain algorithms and logic necessary for the RAID controllers 130 and are divided into those needed for initialization and those that operate at run-time. Initialization software applications 220 consist of the following software functional blocks: CIMOM 222, which is a module that initiates all objects in software applications 220 with the personality attributes entered, SAL 224, which is the application layer upon which the run-time modules execute, and LAL 226, a library of low-level hardware commands used by a RAID transaction processor, as described in the discussion of FIG. 3.

Software applications 220 consist of the following software functional blocks: system manager 228, a module that carries out the run-time executive; SWD 230, a module that provides software supervision function for fault management; PDM 232, a module that handles the personality data within software applications 220; EM 234, a task scheduler that launches software applications 220 under conditional execution; and BBU 236, a module that handles power bus management for battery backup.

FIG. 3 illustrates a functional diagram of interprocess communication (IPC) 300 between two processes that utilize SOAP and XML technologies in accordance with the invention. While IPC 300 is illustrated in the invention as operating within a RAID controller system, it is understood that IPC 300 is enabled for any computing systems or devices with components and configuration, as described below.

Process A 310 and process B 312 represent two separate, conventional computer processes. A computer process is an instance of a running program (for example, SWD 230) in an operating system (for example, operating system 240) of a computing system (for example, RAID controller system 200). A computer process may also be a sub-process that runs within a program, which is known as a child process. In other examples, process A 310 and process B 312 may be processes within one or more different software programs. Architecturally, process A 310 and process B 312 either run on a single processor of a single computer system, across multiple processors of a single computer system, or across multiple processors of multiple computer systems.

Process A 310 and process B 312 further contain a SOAP layer 314 and a SOAP layer 316, as well as an XML layer 318 and an XML layer 320, respectively. XML is a language that is used to define data in a descriptive manner. SOAP is a communication protocol that is used for sending and describing what to do with information such as XML data. While those skilled in the art will appreciate that communication protocols other than XML via SOAP (for example, remote procedure calls (RPC)) could be used to enable the invention, SOAP and XML allow computers with different operating systems and computer programs that have been created with different programming languages to communicate effortlessly. Furthermore, SOAP and XML allow computers to exchange data across networks and through firewalls effortlessly without compromising security.

XML layer 318 represents custom programming code that converts an application-specific command or set of commands into an application non-specific XML command or set of commands conforming to conventional XML standards as defined by the World Wide Web Consortium (W3C). With respect to FIG. 3, XML layer 318 converts a command of process A 310 into XML. SOAP layer 314 represents custom programming code that encodes XML into SOAP messages conforming to conventional SOAP standards as defined by the W3C. With respect to FIG. 3, XML layer 318 passes the XML to SOAP layer 314, and SOAP layer 314 converts the XML into SOAP. XML layer 318 and SOAP layer 314 also decode messages and turn them back into an application-specific command or commands. In the case of bi-directional communication between process A 310 and process B 312, XML layer 320 and SOAP layer 316 of process B 312 have both encoding and decoding capabilities as well.

Process A 310 and process B 312 further contain socket 322 and socket 324, respectively. Sockets are software objects that contain a set of programming requests or function calls for processes of software programs to read and write data, such as SOAP messages, to and from other processes. Sockets function as the IPC medium for process A 310 and process B 312, although other IPC means, as described in the background, could also be used to realize the invention. Socket 322 and socket 324 are written to communicate over a socket connection 326, which is a conventional transport layer for transferring data between computing devices. The transportation method of socket connection 326 varies, depending on the architecture of process A 310 and process B 312. For example, if both processes are run within the same internal computer system, socket connection 326 uses a conventional internal transport method, such as Transmission Control Protocol (TCP), User Datagram Protocol (UDP), or Asynchronous Transfer Mode (ATM). However, if process A 310 and process B 312 are run on different computer systems, an external transport method, such as Transmission Control Protocol/Internet Protocol (TCP/IP), is used. Also, other conventional transport methods could be used to enable IPC 300. Socket 322 and socket 324 are written to support any combination of internal and external socket connections 326, depending on the needs of each computer system, its programs, and its processes. Those skilled in the art will appreciate that using sockets as the basic transport layer will enable IPC between processes of one or more computing systems regardless of their location as long as they are connected by conventional network means, thus enabling IPC between systems across the World Wide Web (WWW).

In operation, process A 310 provides XML layer 318 with a command in the form of a parameter bar or set of variables. XML layer 318 then converts the command into an XML document. The XML is then passed to SOAP layer 314, where information about how a receiving entity should interpret and process the XML is added to create a SOAP message. Process A 310 identifies to socket 322 where the SOAP message should be sent; in this example, the destination is the computing system running process B 312. In another example, the destination is within the same computing system that is running process A 310, in which an internal socket connection would be used for communication. Socket 322 communicates with socket 324 via socket connection 326 and sends the SOAP message. Socket 324 receives and then passes the SOAP message to SOAP layer 316, where the message is decoded and interpreted. The XML portion of the message is passed to XML layer 320, where the original command is turned back into a parameter bar or set of variables that process B 312 understands.

The above description and drawings should only be considered illustrative of exemplary embodiments that achieve the features and advantages of the invention. Modification and substitutions to specific process conditions and structures can be made without departing from the spirit and scope of the invention. Accordingly, the invention is not to be considered as being limited by the foregoing description and drawings, but is only limited by the scope of the appended claims.

What is claimed is:

1. A method for transferring a message from a source computer process to at least one destination computer process, comprising:
converting a message from the source computer process into an extensible markup language (XML) document;
encoding the XML document into a simple object access protocol (SOAP) message;
transmitting the SOAP message to the at least one destination computer process via an interprocess communication (IPC) interface;
decoding the SOAP message to extract the XML document; and
translating the XML document to a language usable by the at least one destination computer process.

2. The method of claim 1, wherein the IPC interface is a socket connection.

3. The method of claim 1, wherein the source and destination computer processes run on at least one redundant array of independent disks (RAID) controller.

4. The method of claim 3, wherein the source computer process and the at least one destination computer process are on the same RAID controller.

5. The method of claim 3, wherein the source computer process and the at least one destination computer process are on different RAID controllers.

6. A system for interprocess communication (IPC), comprising:
a plurality of controllers;
a source computer process running on one of the plurality of controllers;
at least one destination computer process running on at least one of the plurality of controllers;
an IPC interface configured to allow transmission of messages between the source computer process and the at least one destination computer process; and
a message issued from the source computer process for use by the at least one destination computer process;
wherein the source computer process is configured to convert the message into an extensible markup language (XML) document and encode the XML document into a simple object access protocol (SOAP) message, and the at least one destination computer process is configured to decode the SOAP message and translate the message from the XML document into a language usable by the at least one destination computer process.

7. The IPC system of claim 6, wherein the IPC interface is a socket interface.

8. The IPC system of claim 6, wherein the source and destination computer processes run on at least one redundant array of independent disks (RAID) controller.

9. The IPC system of claim 8, wherein the source computer process and the at least one destination computer process are on the same RAID controller.

10. The IPC system of claim 8, wherein the source computer process and the at least one destination computer process are on different RAID controllers.

11. A system for interprocess communication (IPC), comprising:
an IPC interface configured to allow transmission of a first message between at least two computer processes;
a source computer process configured to use the IPC interface to send the first message, the source computer process further comprising:
a source extensible markup language (XML) layer configured to convert the first message into a first XML document; and
a source simple object access protocol (SOAP) layer configured to encode the first XML document into a first SOAP message; and
a destination computer process configured to use the IPC interface to receive the first SOAP message, the destination computer process further comprising:
a destination SOAP layer configured to decode the first SOAP message into the first XML document; and
a destination XML layer configured to convert the first XML document into a transmitted first message, wherein the transmitted first message is in a language usable by the destination computer process.

12. The IPC system of claim 11, wherein the IPC interface is a socket interface and both the source and the destination computer processes further comprise a socket configured to both send and receive the first message.

13. The IPC system of claim 12, wherein the destination XML layer is configured to convert a second message into a second XML document, the destination SOAP layer is configured to encode the second XML document into a second SOAP message, the source SOAP layer is configured to decode the second SOAP message into the second XML document, and the source XML layer is configured to convert the second XML document into a transmitted second message, the transmitted second message being in a language usable by the source computer process.

14. The IPC system of claim 11, wherein the source and destination computer processes run on at least one redundant array of independent disks (RAID) controller.

15. The IPC system of claim 14, wherein the source computer process and the destination computer process are on the same RAID controller.

16. The IPC system of claim 14, wherein the source computer process and the destination computer process are on different RAID controllers.

17. A system for interprocess communication (IPC), comprising:
an IPC interface configured to allow transmission of a first message between at least two computer processes;
a source computer process configured to use the IPC interface to send the first message, the source computer process further comprising:
conversion means to convert the first message into a first document that is not application- or platform-specific; and
encoding means to encode the first document with data to aid with transmission and interpretation of the first document;
a destination computer process configured to use the IPC interface to receive the first document, the destination computer process further comprising:
decoding means to decode the transmission and interpretation data sent with the first document; and
translation means to translate the first document into a transmitted first message, wherein the transmitted first message is in a language usable by the destination computer process.

18. The IPC system of claim 17, wherein the IPC interface is a socket interface and both the source and the destination computer processes further comprise a socket configured to both send and receive the first message.

19. The IPC system of claim 18, wherein the destination computer process further comprises both conversion means and encoding means, and the source computer process further comprises both decoding means and translation means.

20. The IPC system of claim 17, wherein the source and destination computer processes run on at least one controller.

21. The IPC system of claim 20, wherein the source computer process and the destination computer process are on the same controller.

22. The IPC system of claim 20, wherein the source computer process and the destination computer process are on different controllers.
